(19) United States
(12) Patent Application Publication
(10) Pub. No.: US 2026/0266226 A1
(43) Pub. Date: Sep. 10, 2026

(54) ENGINE CONTROL DEVICE, POWER SUPPLY SYSTEM, MOVING OBJECT, ENGINE CONTROL METHOD, AND STORAGE MEDIUM

(71) Applicant: HONDA MOTOR CO., LTD., Tokyo (JP)

(72) Inventor: Takeshi Matsumoto, Wako-shi, Saitama-ken (JP)

(21) Appl. No.: 19/553,711

(22) Filed: Mar. 2, 2026

(30) Foreign Application Priority Data
Mar. 4, 2025 (JP) 2025-033414

(51) Int. Cl. F02C 9/00; F01D 15/10

(52) U.S. Cl. CPC F02C 9/00; F01D 15/10; F05D 2270/02; F05D 2270/053

(57) ABSTRACT

An engine control device controls a gas turbine engine that drives a generator, wherein, in the case where a selection unit selects a first required output power range from a plurality of required output power ranges, a control unit fixes an engine rotational speed, which is the rotational speed of the gas turbine engine, at a first fixed rotational speed, and in the case where the selection unit selects a second required output power range different from the first required output power range, the control unit fixes the engine rotational speed at a second fixed rotational speed different from the first fixed rotational speed.

### CROSS-REFERENCE TO RELATED APPLICATIONS

This application is based upon and claims the benefit of priority from Japanese Patent Application No. 2025-033414 filed on March 4, 2025, the contents of which are incorporated herein by reference.

### BACKGROUND OF THE INVENTION

### FIELD OF THE INVENTION

The present disclosure relates to an engine control device, a power supply system, a moving object, an engine control method, and a storage medium.

### DESCRIPTION OF THE RELATED ART

JP 2022-137452 A discloses an aircraft propulsion system. The aircraft propulsion system uses an engine control unit to control a gas turbine engine.

### SUMMARY OF THE INVENTION

There has been a demand for a more satisfactory engine control device and the like.

The present disclosure has the object of solving the above-described problem.

A first aspect of the present disclosure is characterized by an engine control device that controls a gas turbine engine configured to drive a generator, the engine control device comprising: a selection unit configured to select, according to an operation phase, a required output power range that is a range of output power expected to be required of the gas turbine engine, from a plurality of the required output power ranges determined in advance; and a control unit configured to control the output power of the gas turbine engine according to required output power that is the output power required of the gas turbine engine, wherein, in a case where the selection unit selects a first required output power range from the plurality of required output power ranges, the control unit fixes an engine rotational speed that is a rotational speed of the gas turbine engine, at a first fixed rotational speed, and in a case where the selection unit selects a second required output power range different from the first required output power range from the plurality of required output power ranges, the control unit fixes the engine rotational speed at a second fixed rotational speed different from the first fixed rotational speed.

A second aspect of the present disclosure is characterized by a power supply system comprising: the engine control device according to the first aspect; the generator; the gas turbine engine; and a power storage device configured to store electric power generated by the generator.

A third aspect of the present disclosure is characterized by a moving object comprising the power supply system according to the second aspect.

A fourth aspect of the present disclosure is characterized by an engine control method for controlling a gas turbine engine configured to drive a generator, the engine control method comprising: the step of causing a selection unit to select, according to an operation phase, a required output power range that is a range of output power expected to be required of the gas turbine engine, from a plurality of the required output power ranges determined in advance; and the step of causing a control unit to control the output power of the gas turbine engine according to required output power that is the output power required of the gas turbine engine, wherein, in a case where the selection unit selects a first required output power range from the plurality of required output power ranges, the control unit fixes an engine rotational speed that is a rotational speed of the gas turbine engine, at a first fixed rotational speed, and in a case where the selection unit selects a second required output power range different from the first required output power range from the plurality of required output power ranges, the control unit fixes the engine rotational speed at a second fixed rotational speed different from the first fixed rotational speed.

A fifth aspect of the present disclosure is characterized by a program for causing a computer to execute the engine control method according to the fourth aspect.

A sixth aspect of the present disclosure is characterized by a non-transitory computer-readable storage medium configured to store the program according to the fifth aspect.

According to the present disclosure, a more satisfactory engine control device and the like can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a moving object according to an embodiment of the present disclosure;

FIG. 2 is a schematic diagram showing a configuration of a power supply system according to the embodiment;

FIG. 3 is a block diagram showing a configuration of an engine control device according to the embodiment;

FIG. 4 is a diagram showing an example of a change in required electric power in the embodiment;

FIG. 5 is a graph showing a relationship between an engine rotational speed and output power on a surge line and an efficient operation line of a gas turbine engine according to the embodiment; and

FIG. 6 is a flowchart showing engine control performed by the engine control device according to the embodiment.

### DETAILED DESCRIPTION OF THE INVENTION

In order to efficiently operate a gas turbine engine, it is necessary to change the engine rotational speed of the gas turbine engine together with the output power thereof. However, the energy input to the gas turbine engine when changing the output power is consumed to change the engine rotational speed, and therefore the change in the output power is relatively slow.

The gas turbine engine has a relatively wide output power range at a relatively high rotational speed, and therefore the responsiveness of the output power of the gas turbine engine can be improved. However, if the output power is made relatively small in a state in which the engine rotational speed of the gas turbine engine is relatively high, the efficiency of the gas turbine engine decreases.

According to the engine control device of the present disclosure, a decrease in efficiency can be suppressed while improving the responsiveness of the gas turbine engine.

### Embodiments

### Configuration of Moving Object

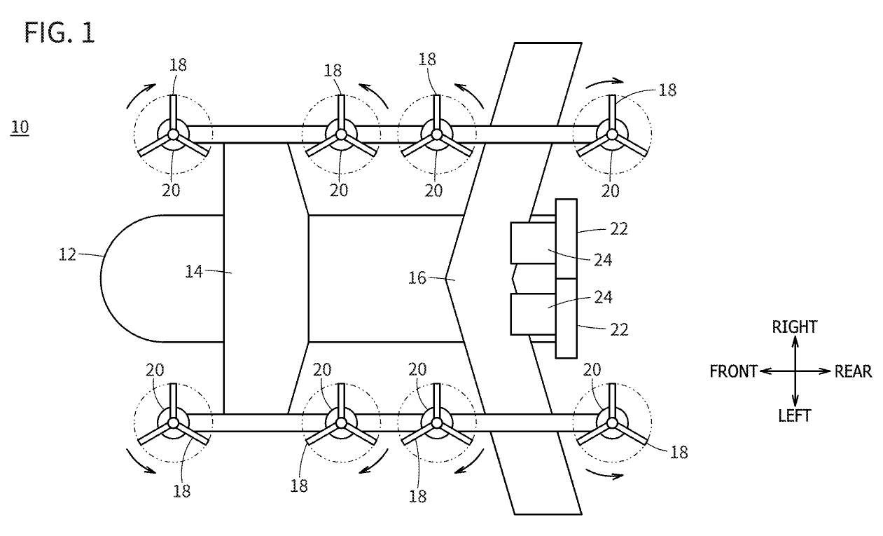

FIG. 1 is a schematic diagram of a moving object 10 according to an embodiment of the present disclosure. The moving object 10 of the embodiment is an electric vertical take-off and landing aircraft (eVTOL aircraft). The moving object 10 includes a fuselage 12. The fuselage 12 is provided with a cockpit, a cabin, and the like. A pilot rides in the cockpit and controls the moving object 10. Passengers and the like ride in the cabin. The moving object 10 may be automatically controlled.

The moving object 10 includes a front wing 14 and a rear wing 16. In the case where the moving object 10 moves forward, lift is generated in each of the front wing 14 and the rear wing 16.

The moving object 10 includes eight VTOL rotors 18 and two cruise rotors 22. One VTOL electric motor 20 is provided for one VTOL rotor 18. The VTOL electric motor 20 is a single three-phase motor. One cruise electric motor 24 is provided for one cruise rotor 22. The cruise electric motor 24 is a dual three-phase motor.

### Configuration of Power Supply System

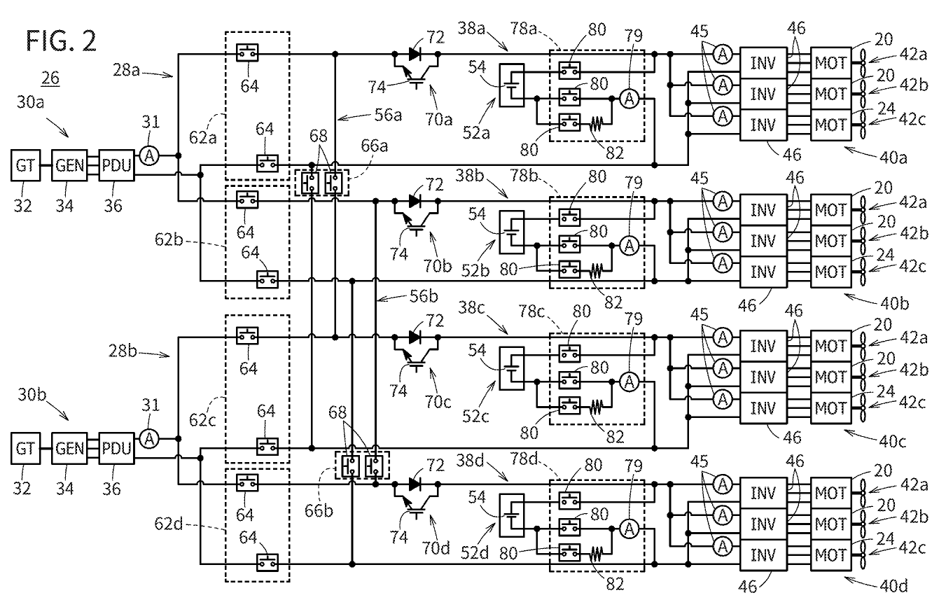

FIG. 2 is a schematic diagram showing a configuration of a power supply system 26 according to the embodiment. The power supply system 26 includes two power supply subsystems, that is, a first power supply subsystem 28a and a second power supply subsystem 28b. The power supply system 26 includes two power generation devices 30 as main power sources. The two power generation devices 30 are a power generation device 30a and a power generation device 30b. The power generation device 30a is provided in the first power supply subsystem 28a, and the power generation device 30b is provided in the second power supply subsystem 28b.

Each of the power generation devices 30 includes a gas turbine engine 32, a generator 34, and a power drive unit (hereinafter referred to as a PDU) 36. The generator 34 is a motor generator. The gas turbine engine 32 drives the generator 34. As a result, the generator 34 generates electric power. The PDU 36 converts the AC power generated by the generator 34 into DC power and outputs the DC power. In the case where the gas turbine engine 32 is started, the PDU 36 converts the DC power input to the PDU 36 into AC power, and outputs the AC power to the generator 34. The AC power causes the generator 34 to operate, and the generator 34 starts the gas turbine engine 32.

The power generation devices 30 each include a current sensor 31. The current sensor 31 detects the current of electric power input to and output from each power generation device 30. The current sensor 31 is provided on the positive wire, but may be provided on the negative wire.

The power generation devices 30 may each include various sensors such as a voltage sensor, and elements such as a fuse, a relay, a breaker, a diode, a transistor, a resistor, a coil, and a capacitor.

The power supply system 26 includes four power supply circuits 38. The four power supply circuits 38 are a power supply circuit 38a, a power supply circuit 38b, a power supply circuit 38c, and a power supply circuit 38d.

The power supply system 26 includes four load modules 40. The four load modules 40 are a load module 40a, a load module 40b, a load module 40c, and a load module 40d.

The power supply circuit 38a supplies, to the load module 40a, the DC power supplied from the power generation device 30a. The power supply circuit 38b supplies, to the load module 40b, the DC power supplied from the power generation device 30a. The power supply circuit 38c supplies, to the load module 40c, the DC power supplied from the power generation device 30b. The power supply circuit 38d supplies, to the load module 40d, the DC power supplied from the power generation device 30b.

The load modules 40 each include three load devices 42. The three load devices 42 are a load device 42a, a load device 42b, and a load device 42c.

The load device 42a and the load device 42b each include a drive device 46 and the VTOL electric motor 20. The load device 42c includes the drive device 46 and the cruise electric motor 24. The drive device 46 is an inverter including a switching element. By controlling the switching element, the drive device 46 converts the DC power input to the drive device 46 into three-phase AC power, and outputs the three-phase AC power to the VTOL electric motor 20 or the cruise electric motor 24. By controlling the switching element, the drive device 46 can disconnect the load device 42 from the power supply circuit 38.

It should be noted that the cruise electric motor 24 of the load device 42c of the load module 40a and the cruise electric motor 24 of the load device 42c of the load module 40c are the same electric motor. Further, the cruise electric motor 24 of the load device 42c of the load module 40b and the cruise electric motor 24 of the load device 42c of the load module 40d are the same electric motor. As described above, the cruise electric motor 24 is a dual three-phase motor and is driven by two drive devices 46.

The load devices 42 each include a current sensor 45. The current sensor 45 detects the current of electric power input to and output from each load device 42. The current sensor 45 is provided on the positive wire, but may be provided on the negative wire.

The load devices 42 may each include various sensors such as a voltage sensor, and elements such as a fuse, a relay, a breaker, a diode, a transistor, a resistor, a coil, and a capacitor.

The power supply system 26 includes four power storage devices 52. The four power storage devices 52 are a power storage device 52a, a power storage device 52b, a power storage device 52c, and a power storage device 52d. The power storage device 52 is connected to each power supply circuit 38. The power storage device 52 is connected in parallel with the power generation device 30. The power storage devices 52 each include a battery 54. The battery 54 is, for example, a lithium ion battery.

The power storage devices 52 may each include various sensors such as a voltage sensor, and elements such as a fuse, a relay, a breaker, a diode, a transistor, a resistor, a coil, and a capacitor.

The power supply circuit 38a and the power supply circuit 38c are connected by a connection circuit 56a. The power supply circuit 38b and the power supply circuit 38d are connected by a connection circuit 56b.

The power supply system 26 includes four first disconnection devices 62. The four first disconnection devices 62 are a first disconnection device 62a, a first disconnection device 62b, a first disconnection device 62c, and a first disconnection device 62d. The first disconnection devices 62 each include two contactors 64. One contactor 64 is provided on the positive wire, and another contactor 64 is provided on the negative wire.

The first disconnection device 62a can disconnect the power generation device 30a from the power supply circuit 38a. The first disconnection device 62b can disconnect the power generation device 30a from the power supply circuit 38b. The first disconnection device 62c can disconnect the power generation device 30b from the power supply circuit 38c. The first disconnection device 62d can disconnect the power generation device 30b from the power supply circuit 38d.

The power supply system 26 includes two connection devices 66. The two connection devices 66 are a connection device 66a and a connection device 66b. The connection devices 66 each include two contactors 68. One contactor 68 is provided on the positive wire, and another contactor 68 is provided on the negative wire.

The connection device 66a can connect the power supply circuit 38a and the power supply circuit 38c via the connection circuit 56a. The connection device 66b can connect the power supply circuit 38b and the power supply circuit 38d via the connection circuit 56b.

The power supply system 26 includes four backflow prevention devices 70. The four backflow prevention devices 70 are a backflow prevention device 70a, a backflow prevention device 70b, a backflow prevention device 70c, and a backflow prevention device 70d. The backflow prevention device 70a is provided on the positive side of the power supply circuit 38a. The backflow prevention device 70b is provided on the positive side of the power supply circuit 38b. The backflow prevention device 70c is provided on the positive side of the power supply circuit 38c. The backflow prevention device 70d is provided on the positive side of the power supply circuit 38d. Each backflow prevention device 70 may be provided on the negative side of each power supply circuit 38.

The backflow prevention devices 70 each include a diode 72, and an insulated gate bipolar transistor (hereinafter, referred to as an IGBT) 74. Normally, the IGBT 74 is turned off. In the case where the IGBT 74 is OFF, the diode 72 prevents a backflow of the current in each of the power supply circuit 38a, the power supply circuit 38b, the power supply circuit 38c, and the power supply circuit 38d. In the case where the gas turbine engine 32 is started, the IGBT 74 is turned on. In the case where the IGBT 74 is ON, by bypassing the diode 72, the backflow of the current is allowed in each of the power supply circuits 38. As a result, the electric power of the battery 54 can be supplied to the generator 34. Instead of the IGBT 74, an element such as a contactor or a relay may be used in each of the backflow prevention devices 70.

The power supply system 26 includes four second disconnection devices 78. The four second disconnection devices 78 are a second disconnection device 78a, a second disconnection device 78b, a second disconnection device 78c, and a second disconnection device 78d.

The second disconnection devices 78 each include three contactors 80 and one precharge resistor 82. One contactor 80 of the three contactors 80 is provided on the positive wire. Another contactor 80 of the three contactors 80 is provided on the negative wire. Still another contactor 80 of the three contactors 80 is provided in a precharge circuit that bypasses the contactor 80 provided on the negative wire. The precharge resistor 82 is provided in series with the contactor 80 in the precharge circuit.

The second disconnection device 78a can disconnect the power storage device 52a from the power supply circuit 38a. The second disconnection device 78b can disconnect the power storage device 52b from the power supply circuit 38b. The second disconnection device 78c can disconnect the power storage device 52c from the power supply circuit 38c. The second disconnection device 78d can disconnect the power storage device 52d from the power supply circuit 38d.

In the case where the power generation device 30a and the load module 40a are precharged with the DC power of the power storage device 52a, the second disconnection device 78a outputs the DC power from the power storage device 52a to the power supply circuit 38a via the precharge circuit. In the case where the power generation device 30a and the load module 40b are precharged with the DC power of the power storage device 52b, the second disconnection device 78b outputs the DC power from the power storage device 52b to the power supply circuit 38b via the precharge circuit. In the case where the power generation device 30b and the load module 40c are precharged with the DC power of the power storage device 52c, the second disconnection device 78c outputs the DC power from the power storage device 52c to the power supply circuit 38c via the precharge circuit. In the case where the power generation device 30b and the load module 40d are precharged with the DC power of the power storage device 52d, the second disconnection device 78d outputs the DC power from the power storage device 52d to the power supply circuit 38d via the precharge circuit.

The second disconnection devices 78 each include a current sensor 79. The current sensor 79 detects the current of electric power input to and output from each second disconnection device 78.

### Configuration of Engine Control Device

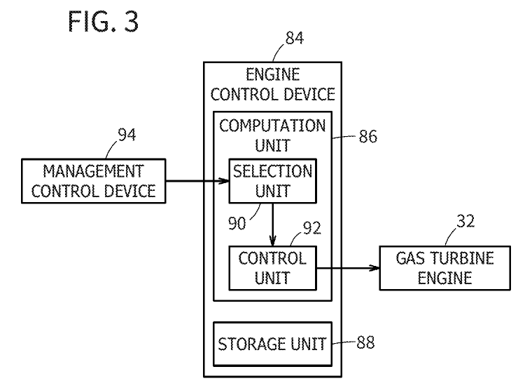

The power supply system 26 includes an engine control device 84 that controls the gas turbine engine 32. FIG. 3 is a block diagram showing a configuration of the engine control device 84 according to the embodiment.

The engine control device 84 includes a computation unit 86 and a storage unit 88. The computation unit 86 is, for example, a processor such as a central processing unit (CPU) or a graphics processing unit (GPU). The computation unit 86 includes a selection unit 90 and a control unit 92. The selection unit 90 and the control unit 92 are realized by the computation unit 86 executing a program stored in the storage unit 88. At least part of the selection unit 90 and the control unit 92 may be realized by an integrated circuit such as an application specific integrated circuit (ASIC) or a field-programmable gate array (FPGA). At least part of the selection unit 90 and the control unit 92 may be realized by an electronic circuit including a discrete device.

The storage unit 88 is a non-transitory computer-readable tangible storage medium. The storage unit 88 is constituted by a volatile memory (not shown) and a non-volatile memory (not shown). The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the non-volatile memory. At least part of the storage unit 88 may be included in the processor, the integrated circuit, or the like described above. At least part of the storage unit 88 may be mounted on a device connected to the moving object 10 via a network.

The selection unit 90 selects a required output power range based on the operation phase (flight phase) of the moving object 10. The information about the operation phase is acquired from a management control device 94. The management control device 94 is a control device that manages the engine control device 84. The management control device 94 manages a power generation control device, a junction box control device, a battery control device, and the like (all of which are not shown), in addition to the engine control device 84. The power generation control device controls the PDUs 36. The junction box control device controls the first disconnection devices 62, the connection devices 66, the IGBTs 74, and the like. The battery control device monitors the state of charge (SOC) of the batteries 54, and controls the second disconnection devices 78 and the like. The operation phase and the required output power range will be described in detail later.

The control unit 92 controls each gas turbine engine 32 according to the required output power for the gas turbine engine 32 (the output power required of the gas turbine engine 32). The required output power for the gas turbine engine 32 that drives the generator 34 is determined according to the load of the generator 34 that changes according to the required electric power of the load module 40 and the power storage device 52 (the electric power required by the load module 40 and the power storage device 52).

The control unit 92 fixes the engine rotational speed of the gas turbine engine 32 at a fixed rotational speed corresponding to the required output power range selected by the selection unit 90. In a state in which the engine rotational speed of the gas turbine engine 32 is fixed at the fixed rotational speed, the output power of the gas turbine engine 32 is changed according to the required output power. The fixed rotational speed will be described in detail later.

### Required Electric Power

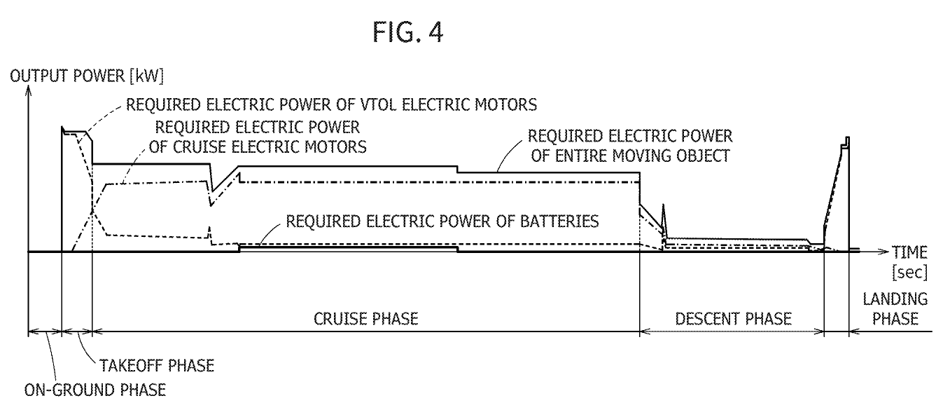

FIG. 4 is a diagram showing an example of a change in required electric power in the embodiment. FIG. 4 shows changes in the required electric power of the VTOL electric motors 20, the cruise electric motors 24, and the batteries 54, and changes in the sum of the required electric power of the VTOL electric motors 20, the cruise electric motors 24, and the batteries 54, that is, the required electric power of the entire moving object 10. FIG. 4 shows the transition of the required electric power from when the moving object 10 is on standby on the ground, takes off, cruises, until it lands.

As shown in FIG. 4, the range of the required electric power of the entire moving object 10 differs depending on the operation phase. The operation phase indicates, for example, an on-ground phase (a phase of standby on the ground), a takeoff phase, a cruise phase, a descent phase, and a landing phase.

In the on-ground phase, the moving object 10 is on standby on the ground, and the VTOL electric motors 20 and the cruise electric motors 24 are stopped or idling. Therefore, in the on-ground phase, the required electric power of the entire moving object 10 is relatively small, and the range of change in the required electric power is relatively small.

In the takeoff phase, since the moving object 10 takes off vertically, the required electric power of the VTOL electric motors 20 is relatively large. Further, since the lift is adjusted according to the atmospheric condition, the range of change in the required electric power of the VTOL electric motors 20 is relatively large. In the takeoff phase, the required electric power of the cruise electric motors 24 gradually increases toward the cruise phase. Therefore, in the takeoff phase, the required electric power of the entire moving object 10 changes from a relatively small state to a relatively large state, and the range of change in the required electric power is relatively large.

In the cruise phase, since lift is generated in the front wing 14 and the rear wing 16, the required electric power of the VTOL electric motors 20 is relatively small. In the cruise phase, since thrust in the horizontal direction is required, the required electric power of the cruise electric motors 24 is relatively large, but the change in the thrust is small, and the change in the required electric power of the cruise electric motors 24 is therefore small. Accordingly, in the cruise phase, the required electric power of the entire moving object 10 is relatively large, and the change in the required electric power is relatively small.

In the descent phase, since the lift is adjusted to descend the moving object 10, the required electric power of the VTOL electric motors 20 is not so large. In the descent phase, since the moving object 10 is decelerated, the required electric power of the cruise electric motors 24 is also not so large. Therefore, in the descent phase, the required electric power of the entire moving object 10 is moderate, and the range of change in the required electric power is also moderate.

In the landing phase, since the moving object 10 lands vertically, the required electric power of the VTOL electric motors 20 is relatively large. Further, since the lift is adjusted according to the atmospheric condition, the range of change in the required electric power of the VTOL electric motors 20 is relatively large. In the landing phase, the required electric power of the cruise electric motors 24 is relatively small. Therefore, in the landing phase, the required electric power of the entire moving object 10 changes from a relatively small state to a relatively large state, and the range of change in the required electric power is relatively large.

### Required Output Power Range

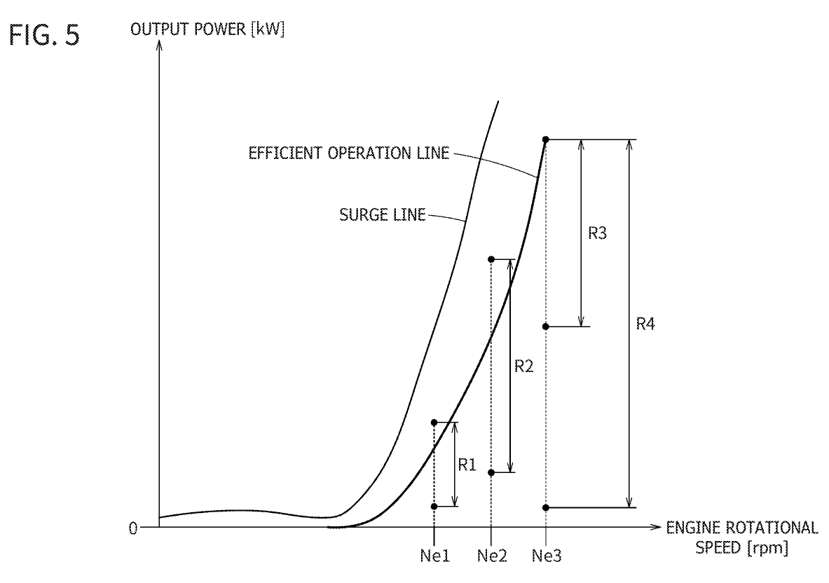

FIG. 5 is a graph showing a relationship between an engine rotational speed and output power on a surge line and an efficient operation line of the gas turbine engine 32 according to the embodiment.

In the case where the operating point, which is a combination of the engine rotational speed and the output power of the gas turbine engine 32, is located in a region above the surge line, there is a possibility that a surge occurs in the gas turbine engine 32. By driving the gas turbine engine 32 so that the operating point of the gas turbine engine 32 is located on the efficient operation line, the gas turbine engine 32 can be efficiently operated. The efficient operation line may not be a line indicating the most efficient operating point of the gas turbine engine 32. The efficient operation line may be set so as to suppress a surge or the like of the gas turbine engine 32 due to rotational fluctuation or the like of the gas turbine engine 32. It should be noted that, in the case where the gas turbine engine 32 is efficiently operated, the amount of fuel consumed by the gas turbine engine 32 with respect to the output power of the gas turbine engine 32 can be suppressed.

In the engine control device 84 of the present disclosure, four required output power ranges are set. The four required output power ranges are a first required output power range R1, a second required output power range R2, a third required output power range R3, and a fourth required output power range R4.

The first required output power range R1 is a range selected in the case where the output power expected to be required of the gas turbine engine 32 is relatively low, and more specifically, is selected in the case where the operation phase of the moving object 10 is the on-ground phase. The second required output power range R2 is a range selected in the case where the output power expected to be required of the gas turbine engine 32 is moderate, and more specifically, is selected in the case where the operation phase of the moving object 10 is the descent phase.

The third required output power range R3 is a range selected in the case where the output power expected to be required of the gas turbine engine 32 is relatively high, and more specifically, is selected in the case where the operation phase of the moving object 10 is the cruise phase. The fourth required output power range R4 is a range selected in the case where the output power expected to be required of the gas turbine engine 32 varies in a wide range, and more specifically, is selected in the case where the operation phase of the moving object 10 is the takeoff phase or the landing phase.

As shown in FIG. 5, the minimum value of the second required output power range R2 is greater than the minimum value of the first required output power range R1. Further, the maximum value of the second required output power range R2 is greater than the maximum value of the first required output power range R1. Furthermore, the maximum value of the first required output power range R1 is greater than the minimum value of the second required output power range R2. That is, on the graph in FIG. 5, the first required output power range R1 and the second required output power range R2 overlap each other.

As shown in FIG. 5, the minimum value of the third required output power range R3 is greater than the minimum value of the second required output power range R2. Further, the maximum value of the third required output power range R3 is greater than the maximum value of the second required output power range R2. Furthermore, the maximum value of the second required output power range R2 is greater than the minimum value of the third required output power range R3. That is, on the graph in FIG. 5, the second required output power range R2 and the third required output power range R3 overlap each other.

A fixed rotational speed is correspondingly set for each of the four required output power ranges. A first fixed rotational speed Ne1 [rpm] is set for the first required output power range R1. In the case where the engine rotational speed is the first fixed rotational speed Ne1 [rpm], the efficient operation line is included in the first required output power range R1. That is, the first fixed rotational speed Ne1 [rpm] is set based on the first required output power range R1 and the efficiency obtained when the gas turbine engine 32 is operated within the first required output power range R1.

A second fixed rotational speed Ne2 [rpm] is set for the second required output power range R2. In the case where the engine rotational speed is the second fixed rotational speed Ne2 [rpm], the efficient operation line is included in the second required output power range R2. That is, the second fixed rotational speed Ne2 [rpm] is set based on the second required output power range R2 and the efficiency obtained when the gas turbine engine 32 is operated within the second required output power range R2.

A third fixed rotational speed Ne3 [rpm] is set for the third required output power range R3. In the case where the engine rotational speed is the third fixed rotational speed Ne3 [rpm], the efficient operation line is included in the third required output power range R3. That is, the third fixed rotational speed Ne3 [rpm] is set based on the third required output power range R3 and the efficiency obtained when the gas turbine engine 32 is operated within the third required output power range R3.

The third fixed rotational speed Ne3 [rpm] is set for the fourth required output power range R4. In the case where the engine rotational speed is the third fixed rotational speed Ne3 [rpm], the efficient operation line is included in the fourth required output power range R4. That is, the third fixed rotational speed Ne3 [rpm] is set based on the fourth required output power range R4 and the efficiency obtained when the gas turbine engine 32 is operated within the fourth required output power range R4.

As described above, in the present embodiment, the first required output power range R1, the second required output power range R2, the third required output power range R3, and the fourth required output power range R4 are made different from each other. As a result, it is possible to improve the responsiveness of the output power of the gas turbine engine 32 while suppressing the amount of fuel consumed by the gas turbine engine 32 with respect to the required output power in a wide range.

### Engine Control

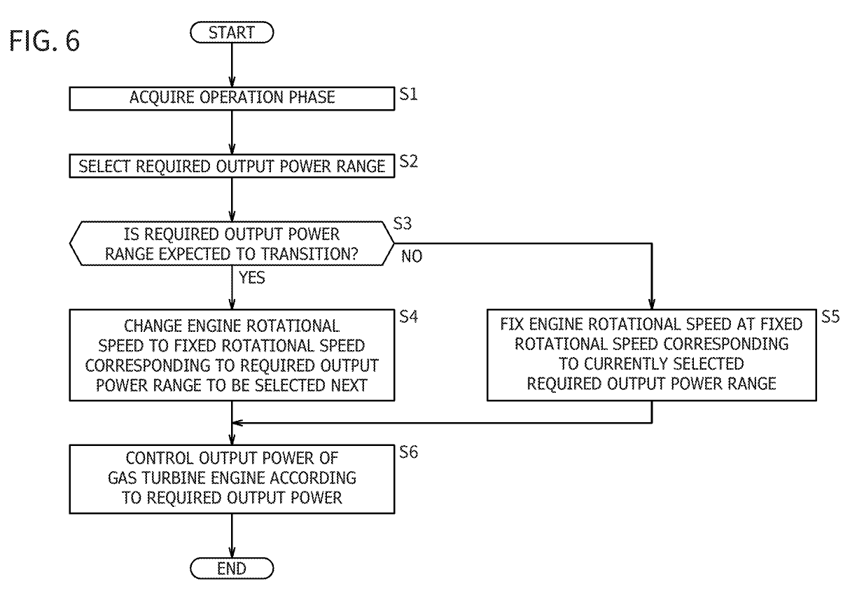

FIG. 6 is a flowchart showing engine control performed by the engine control device 84 according to the embodiment. The engine control is repeatedly executed at a predetermined cycle while the gas turbine engine 32 is driven.

In step S1, the selection unit 90 acquires the operation phase from the management control device 94. Thereafter, the process proceeds to step S2.

In step S2, the selection unit 90 selects a required output power range corresponding to the operation phase. Thereafter, the process proceeds to step S3.

In step S3, the selection unit 90 determines whether or not the selected required output power range is expected to transition. In the case where it is determined that the selected required output power range is expected to transition, the process proceeds to step S4. In the case where it is determined that the selected required output power range is not expected to transition, the process proceeds to step S5.

In step S4, the control unit 92 changes the engine rotational speed to a fixed rotational speed corresponding to the required output power range to be selected next. Thereafter, the process proceeds to step S6.

In step S5, the control unit 92 fixes the engine rotational speed at a fixed rotational speed corresponding to the currently selected required output power range. Thereafter, the process proceeds to step S6.

In step S6, the control unit 92 controls the output power of the gas turbine engine 32 according to the required output power. Thereafter, the engine control is ended.

### Advantageous Effects

In order to efficiently operate the gas turbine engine 32, it is necessary for the engine rotational speed to be changed according to a change in the output power of the gas turbine engine 32 so as to be along the efficient operation line in FIG. 5. However, the energy input to the gas turbine engine 32 when changing the output power is consumed to change the engine rotational speed, and therefore the change in the output power is relatively slow.

The engine control device 84 according to the embodiment selects one required output power range from the plurality of required output power ranges based on the operation phase. In the case where the first required output power range R1 is selected, the output power of the gas turbine engine 32 is controlled according to the required output power for the gas turbine engine 32 in a state in which the engine rotational speed is fixed at the first fixed rotational speed Ne1 [rpm]. In the case where the second required output power range R2 is selected, the output power of the gas turbine engine 32 is controlled according to the required output power for the gas turbine engine 32 in a state in which the engine rotational speed is fixed at the second fixed rotational speed Ne2 [rpm]. In each operation phase, the output power of the gas turbine engine 32 is controlled in a state in which the engine rotational speed is fixed, and therefore the responsiveness of the output power of the gas turbine engine 32 can be improved.

In the engine control device 84 according to the embodiment, in the case where the engine rotational speed is the first fixed rotational speed Ne1 [rpm], the efficient operation line is included in the first required output power range R1. That is, the first fixed rotational speed Ne1 [rpm] corresponding to the first required output power range R1 is set based on the efficiency obtained when the gas turbine engine 32 is operated so that the output power falls within the first required output power range R1. Further, the second fixed rotational speed Ne2 [rpm] is set for the second required output power range R2. That is, the second fixed rotational speed Ne2 [rpm] corresponding to the second required output power range R2 is set based on the efficiency obtained when the gas turbine engine 32 is operated so that the output power falls within the second required output power range R2. As a result, it is possible to suppress a decrease in the efficiency of the gas turbine engine 32 while improving the responsiveness of the output power of the gas turbine engine 32.

In the engine control device 84 according to the embodiment, in the case where the operation phase transitions and the selected required output power range is expected to transition from the first required output power range R1 to the second required output power range R2, the engine rotational speed is changed from the first fixed rotational speed Ne1 to the second fixed rotational speed Ne2. The transition of the operation phase can be predicted in advance. By changing the engine rotational speed to the fixed rotational speed corresponding to the required output power range to be selected next, it is possible to suppress a decrease in the responsiveness of the output power of the gas turbine engine 32 due to the change in the engine rotational speed.

The following supplementary notes are further disclosed in relation to the above-described embodiment.

### Supplementary Note 1

The engine control device (84) of the present disclosure is an engine control device that controls the gas turbine engine (32) configured to drive the generator (34), and includes: the selection unit (90) configured to select, according to the operation phase, a required output power range that is a range of output power expected to be required of the gas turbine engine, from a plurality of the required output power ranges determined in advance; and the control unit (92) configured to control the output power of the gas turbine engine according to required output power that is the output power required of the gas turbine engine, wherein, in the case where the selection unit selects the first required output power range from the plurality of required output power ranges, the control unit fixes the engine rotational speed that is the rotational speed of the gas turbine engine, at the first fixed rotational speed, and in the case where the selection unit selects the second required output power range different from the first required output power range, the control unit fixes the engine rotational speed at the second fixed rotational speed different from the first fixed rotational speed. According to this feature, the responsiveness of the output power of the gas turbine engine can be improved.

### Supplementary Note 2

In the engine control device according to Supplementary Note 1, the minimum value of the second required output power range may be greater than the minimum value of the first required output power range, the maximum value of the second required output power range may be greater than the maximum value of the first required output power range, and the second fixed rotational speed may be higher than the first fixed rotational speed.

### Supplementary Note 3

In the engine control device according to Supplementary Note 1, the first fixed rotational speed may be set based on the first required output power range and the efficiency obtained when the gas turbine engine is operated within the first required output power range, and the second fixed rotational speed may be set based on the second required output power range and the efficiency obtained when the gas turbine engine is operated within the second required output power range.

### Supplementary Note 4

In the engine control device according to Supplementary Note 1, the selection unit may determine whether or not a state of selecting the first required output power range is expected to transition to a state of selecting the second required output power range, and in the case where the selection unit determines that the state of selecting the first required output power range is expected to transition to the state of selecting the second required output power range, the control unit may change the engine rotational speed from the first fixed rotational speed to the second fixed rotational speed.

### Supplementary Note 5

In the engine control device according to Supplementary Note 1, in the case where the selection unit selects the third required output power range different from the first required output power range and the second required output power range, the control unit may fix the engine rotational speed at the third fixed rotational speed different from the first fixed rotational speed and the second fixed rotational speed, and in the case where the selection unit selects the fourth required output power range different from the first required output power range, the second required output power range, and the third required output power range, the control unit may fix the engine rotational speed at the third fixed rotational speed.

### Supplementary Note 6

The power supply system of the present disclosure includes: the engine control device according to Supplementary Note 1; the generator; the gas turbine engine; and the power storage device configured to store electric power generated by the generator.

### Supplementary Note 7

The moving object (10) of the present disclosure includes the power supply system according to Supplementary Note 6.

### Supplementary Note 8

The engine control method of the present disclosure is an engine control method for controlling the gas turbine engine configured to drive the generator, the engine control method including: the step of causing the selection unit to select, according to the operation phase, a required output power range that is a range of output power expected to be required of the gas turbine engine, from a plurality of the required output power ranges determined in advance; and the step of causing the control unit to control the output power of the gas turbine engine according to required output power that is the output power required of the gas turbine engine, wherein, in the case where the selection unit selects the first required output power range from the plurality of required output power ranges, the control unit fixes the engine rotational speed that is the rotational speed of the gas turbine engine, at the first fixed rotational speed, and in the case where the selection unit selects the second required output power range different from the first required output power range, the control unit fixes the engine rotational speed at the second fixed rotational speed different from the first fixed rotational speed.

### Supplementary Note 9

In the engine control method according to Supplementary Note 8, the minimum value of the second required output power range may be greater than the minimum value of the first required output power range, the maximum value of the second required output power range may be greater than the maximum value of the first required output power range, and the second fixed rotational speed may be higher than the first fixed rotational speed.

### Supplementary Note 10

In the engine control method according to Supplementary Note 8, the first fixed rotational speed may be set based on the first required output power range and the efficiency obtained when the gas turbine engine is operated within the first required output power range, and the second fixed rotational speed may be set based on the second required output power range and the efficiency obtained when the gas turbine engine is operated within the second required output power range.

### Supplementary Note 11

The engine control method according to Supplementary Note 8 may further include: the step of causing the selection unit to determine whether or not a state of selecting the first required output power range is expected to transition to a state of selecting the second required output power range; and the step of, in the case where the selection unit determines that the state of selecting the first required output power range is expected to transition to the state of selecting the second required output power range, causing the control unit to change the engine rotational speed from the first fixed rotational speed to the second fixed rotational speed.

### Supplementary Note 12

In the engine control method according to Supplementary Note 8, in the case where the selection unit selects the third required output power range different from the first required output power range and the second required output power range, the control unit may fix the engine rotational speed at the third fixed rotational speed different from the first fixed rotational speed and the second fixed rotational speed, and in the case where the selection unit selects the fourth required output power range different from the first required output power range, the second required output power range, and the third required output power range, the control unit may fix the engine rotational speed at the third fixed rotational speed.

### Supplementary Note 13

The program of the present disclosure causes a computer to execute the engine control method according to any one of Supplementary Notes 8 to 12.

### Supplementary Note 14

The non-transitory computer-readable storage medium of the present disclosure stores the program according to Supplementary Note 13.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. An engine control device that controls a gas turbine engine configured to drive a generator, the engine control device comprising:
one or more processors that execute computer-executable instructions stored in a memory,
wherein the one or more processors execute the computer-executable instructions to cause the engine control device to:
select, according to an operation phase, a required output power range that is a range of output power expected to be required of the gas turbine engine, from a plurality of the required output power ranges determined in advance;
control the output power of the gas turbine engine according to required output power that is the output power required of the gas turbine engine;
in a case where a first required output power range is selected from the plurality of required output power ranges, fix an engine rotational speed that is a rotational speed of the gas turbine engine, at a first fixed rotational speed; and
in a case where a second required output power range different from the first required output power range is selected from the plurality of required output power ranges, fix the engine rotational speed at a second fixed rotational speed different from the first fixed rotational speed.

2. The engine control device according to claim 1, wherein
a minimum value of the second required output power range is greater than a minimum value of the first required output power range,
a maximum value of the second required output power range is greater than a maximum value of the first required output power range, and
the second fixed rotational speed is higher than the first fixed rotational speed.

3. The engine control device according to claim 1, wherein
the first fixed rotational speed is set based on the first required output power range and an efficiency obtained when the gas turbine engine is operated within the first required output power range, and
the second fixed rotational speed is set based on the second required output power range and the efficiency obtained when the gas turbine engine is operated within the second required output power range.

4. The engine control device according to claim 1, wherein
the one or more processors cause the engine control device to determine whether or not a state of selecting the first required output power range is expected to transition to a state of selecting the second required output power range, and
in a case where it is determined that the state of selecting the first required output power range is expected to transition to the state of selecting the second required output power range, the one or more processors cause the engine control device to change the engine rotational speed from the first fixed rotational speed to the second fixed rotational speed.

5. The engine control device according to claim 1, wherein
in a case where a third required output power range different from the first required output power range and the second required output power range is selected, the one or more processors cause the engine control device to fix the engine rotational speed at a third fixed rotational speed different from the first fixed rotational speed and the second fixed rotational speed, and
in a case where a fourth required output power range different from the first required output power range, the second required output power range, and the third required output power range is selected, the one or more processors cause the engine control device to fix the engine rotational speed at the third fixed rotational speed.

6. A power supply system, comprising:
the engine control device according to claim 1;
the generator;
the gas turbine engine; and
a power storage device configured to store electric power generated by the generator.

7. A moving object comprising the power supply system according to claim 6.

8. An engine control method for controlling a gas turbine engine configured to drive a generator, the engine control method being executed by one or more processors and comprising:
selecting, according to an operation phase, a required output power range that is a range of output power expected to be required of the gas turbine engine, from a plurality of the required output power ranges determined in advance;
controlling the output power of the gas turbine engine according to required output power that is the output power required of the gas turbine engine;
in a case where a first required output power range is selected from the plurality of required output power ranges, fixing an engine rotational speed that is a rotational speed of the gas turbine engine, at a first fixed rotational speed; and
in a case where a second required output power range different from the first required output power range is selected from the plurality of required output power ranges, fixing the engine rotational speed at a second fixed rotational speed different from the first fixed rotational speed.

9. The engine control method according to claim 8, wherein
a minimum value of the second required output power range is greater than a minimum value of the first required output power range,
a maximum value of the second required output power range is greater than a maximum value of the first required output power range, and
the second fixed rotational speed is higher than the first fixed rotational speed.

10. The engine control method according to claim 8, wherein
the first fixed rotational speed is set based on the first required output power range and an efficiency obtained when the gas turbine engine is operated within the first required output power range, and
the second fixed rotational speed is set based on the second required output power range and the efficiency obtained when the gas turbine engine is operated within the second required output power range.

11. The engine control method according to claim 8, wherein
it is determined whether or not a state of selecting the first required output power range is expected to transition to a state of selecting the second required output power range, and
in a case where it is determined that the state of selecting the first required output power range is expected to transition to the state of selecting the second required output power range, the engine rotational speed is changed from the first fixed rotational speed to the second fixed rotational speed.

12. The engine control method according to claim 8, wherein
in a case where a third required output power range different from the first required output power range and the second required output power range is selected, the engine rotational speed is fixed at a third fixed rotational speed different from the first fixed rotational speed and the second fixed rotational speed, and
in a case where a fourth required output power range different from the first required output power range, the second required output power range, and the third required output power range is selected, the engine rotational speed is fixed at the third fixed rotational speed.

13. A non-transitory computer-readable storage medium configured to store a program for causing a computer to execute the engine control method according to claim 8.
